(19) United States
(12) Patent Application Publication
(10) Pub. No.: US 2005/0051939 A1
(43) Pub. Date: Mar. 10, 2005

(54) Centering and clamping pilot tool

(76) Inventor: Michel Beffrieu, Gournay (FR)

Correspondence Address: YOUNG & THOMPSON, 745 SOUTH 23RD STREET, 2ND FLOOR, ARLINGTON, VA, 22202, US

(21) Appl. No.: 10/495,784

(22) PCT Filed: Nov. 7, 2002
(86) PCT No.: PCT/FR02/03807

(30) Foreign Application Priority Data
Nov. 16, 2001 (FR) 01/14893

(51) Int. Cl. B23Q 3/08

(52) U.S. Cl. 269/32

(57) ABSTRACT

The invention concerns a centering and clamping pilot tool comprising a hollow sliding centering part or pilot (4), a slide (1) mounted coaxially mobile inside the recess (3) of the pilot (4), said slide (1) being integral with the rod of an actuator and being connected to at least a clamping hook (16) mounted pivotable about a pin (15) integral with the pilot (4) under the action of the displacement of the slide (1), the slide bearing a pin (14) parallel to the pivot pin (15) of the clamping hook (16), anchored between two flanges of the slide (1) and with which co-operates a groove (17) arranged in the clamping hook (16) mounted pivotable between said flanges (11).

The present invention relates to a centering and clamping pilot tool designed to cooperate with a centering orifice formed in at least one component in order to position said component and fix it in position.

Such tools are conventionally used for fastening metal sheets in position, particularly during the assembly of motor vehicles.

In a known embodiment (FR-A-2 733 930), such a tool comprises a hollow sliding centering part or pilot and a slide mounted movably coaxially inside the recess of the pilot, said slide being integral with the rod of a pneumatic jack and being connected to at least one clamping hook mounted pivotably about a pin integral with the pilot under the action of the displacement of the slide between a retraction position within the pilot and at least one clamping position projecting with respect to the pilot, the pilot comprising a collar surrounding the aperture of its recess for the mounting of a bearing block of the component to be positioned and fixed, a return spring being interposed between the slide and the pilot.

In the tool described and illustrated in FR-A-2 733 930, a link is mounted between the slide and the pivoting hook in order to convert the rectilinear displacement of the slide into a rotation of the hook. This transmission has a complicated construction involving a high outlay, the assembly moreover possessing insufficient mechanical resistance.

In FR-A-2 781 176, it was proposed to equip the pivoting hook with a dog sliding inside a groove of the slide. This solution, although simpler than the preceding one, nevertheless has brittleness, particularly in the region of the dog which, when there is a wear of the groove after a large number of operating cycles, may lead to jamming.

The present invention is accordingly aimed at improving a centering and clamping pilot tool of the type defined in the introduction, so as to overcome the disadvantages of known tools in order to obtain, in particular, a simple and economical structure which has long-term resistance.

To achieve this, the pilot tool according to the invention is characterized in that the slide carries a pin which is parallel to the rotary pin of the clamping hook and is anchored between two cheeks of the slide and with which co-operates a groove formed in the clamping hook mounted pivotably between said cheeks.

Transmission means between the slide and the clamping hook are therefore formed, according to the invention by a pin integral with the slide and a groove formed in the clamping hook. These transmission means are therefore highly simplified, as compared with those described in FR-A-2 733 930, and, furthermore, they have much higher mechanical resistance than the means proposed in FR-A-2 781 176. To be precise, the pin integral with the slide is much more robust than the dog integral with the clamping hook and provided in the prior document. Furthermore, if the tool comprises two clamping hooks pivoting in opposite directions, as in the case of the tool according to FR-A-2 781 176, it is necessary for each clamping hook to be provided with a cantilevered stub, whereas, with the device according to the present invention, a common pin integral with the slide is used for the two clamping hooks.

The invention will be understood clearly from a reading of the following description of an exemplary embodiment, with reference to the accompanying drawing in which:

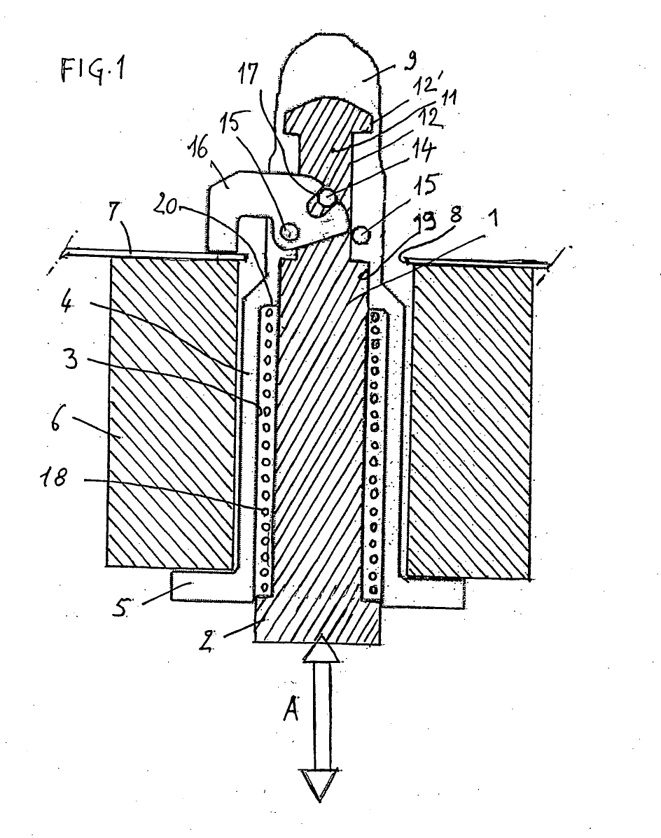

FIG. 1 is a diagrammatic view in axial section of part of the tool, and

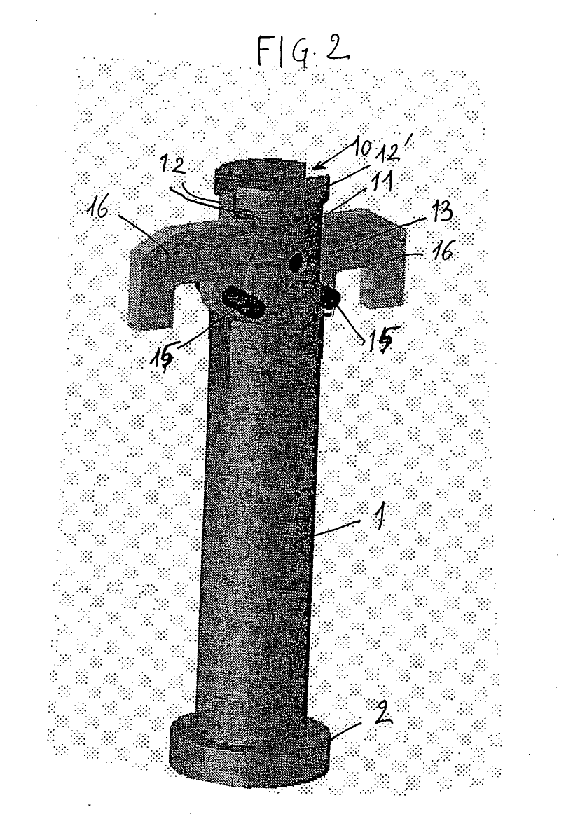

FIG. 2 is a diagrammatic perspective view of the slide and of the clamping levers of the tool of FIG. 1.

The tool illustrated in the drawing comprises a slide 1 integral with the rod of a hydraulic or electrical jack, merely indicated by double arrow A, by means of a shoulder 2.

The slide 1 is mounted movably inside a recess 3 of a hollow sliding part or pilot 4 provided, in the vicinity of the shoulder 2 of the slide 1, with a shoulder 5 serving for receiving a bearing block 6 as at least one component to be centered and clamped, such as a metal sheet 7 provided with an aperture 8 with a passage of the pilot 4. At its end opposite its shoulder 5, the pilot 4 comprises a head 9 in the form of a rounded tip for passage through the aperture 8 of the metal sheet 7.

The slide 1 is provided, at its end opposite its shoulder 2, with an axial slot 10 forming two cheeks 11, on which are formed respectively two opposite setbacks 12 producing a shouldered head 12′. The cheeks 11 are pierced with two aligned bores 13 which are orthogonal to the cheeks 11 and in which a pin 14 is fastened.

The pilot 9 is provided with two pins 15 parallel to the pin 14, a clamping hook 16 being mounted pivotably on each of the pins 15 of the pilot 4 (a single clamping hook 16 is illustrated in FIG. 1). The pins 15 are arranged so as to slide in the setbacks 12 of the cheeks 11 of the slide 1 when the latter is displaced with respect to the pilot 4. The levers 16 are each provided with a groove 17 through which the pin 14 integral with the slide 1 passes. A calibrated helical spring 18 is interposed between the shoulder 2 of the slide 1 and an inner shoulder 20 formed by a radial narrowing 19 of the recess 3 of the pilot 4.

The functioning is as follows.

In a state of rest (not illustrated), the jack rod and, with it, the slide 1 are in the low position (in the drawing), the clamping hooks 16 being retracted within the slot 10 of the slide 1. The pilot 5 is likewise in the low position under the action of the relaxed spring 18.

When the jack is actuated, its rod drives the slide 1, and the rigidity of the spring 18 drives the pilot 4 simultaneously, until the shoulder 5 of the pilot 4 butts against the base of the bearing block 6. From this moment, the slide 1 is displaced inside the pilot 9, at the same time compressing the spring 18. The displacement of the slide 1 alone generates a displacement of the pin 14 in the groove 17 of each of the clamping hooks 16. The clamping hooks 16 pivot outward until they come to bear on the metal sheet 7 with sufficient force to stop the jack rod by means of the correspondingly calibrated helical spring 18. The tool according to the invention thereby adapts automatically to the thickness of the metal sheet 7 (or of a stack of a plurality of metal sheets) in a reliable and sufficient way.

The retraction of the tool takes places by means of a reverse procedure. If, for any reason, the pilot 4 remained in place after retraction of the clamping hooks 16, abutting of the head 12′ of the slide 1 on the pins 15 integral with the pilot 4 would release the wedged pilot 4 which would thus return to its initial position.

1. A centering and clamping pilot tool designed to cooperate with a centering orifice (8) formed in at least one component (7) in order to position said component (7) and fix it in position, said tool comprising a hollow sliding centering part or pilot (4) and a slide (1) mounted movably coaxially inside the recess (3) of the pilot (4), said slide (1) being integral with the rod of a jack and being connected to at least one clamping hook (16) mounted pivotably about a pin (15) integral with the pilot (4) under the action of the displacement of the slide (1) between a retraction position within the pilot (4) and at least one clamping position projecting with respect to the pilot (4), the pilot (4) comprising a collar (5) surrounding the aperture of its recess (3) for the mounting of a bearing block (6) of the component (7) to be positioned and fixed, a return spring (18) being interposed between the slide (1) and the pilot (4), characterized in that the slide (1) carries a pin (14) which is parallel to the rotary pin (15) of the clamping hook (16) and anchored between two cheeks (11) of the slide (1) and with which co-operates a groove (17) formed in the clamping hook (16) mounted pivotably between said cheeks (11).

2. The pilot tool as claimed in claim 1, characterized in that the pivot pins (15) of the levers (16) are mounted slidably in setbacks (12) of the cheeks (11) of the slide (1), said setbacks (12) producing a shouldered head (12′) in said cheeks (11).
